(19) United States
(12) Patent Application Publication
(10) Pub. No.: US 2008/0301173 A1
(43) Pub. Date: Dec. 4, 2008

(54) METHOD AND APPARATUS FOR GENERATING PLAYLIST OF MEDIA CONTENT AND METHOD AND APPARATUS FOR PLAYING MEDIA CONTENT

(75) Inventors: Sung-Ho RYU, Suwon-si (KR); Seok-Hyun Yoon, Seoul (KR); Min-Hyok Bang, Seoul (KR); Won-ho Ryu, Seoul (KR); Hyun-Joo Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/970,214

(22) Filed: Jan. 7, 2008

(30) Foreign Application Priority Data
Jun. 1, 2007 (KR) 10-2007-0053989

(51) Int. Cl. G06F 17/30

(52) U.S. Cl. 707/102; 707/E17.009

(57) ABSTRACT

Provided are a method and apparatus for generating a playlist of media content and a method and apparatus for playing media content. The method of generating a playlist of media content includes providing a user interface for setting a playlist while media content is being played and generating a playlist of media content to be played according to playlist settings set through the user interface.

### CROSS-REFERENCE TO RELATED APPLICATION

This application claims priority from Korean Patent Application No. 10-2007-0053989 filed on Jun. 1, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to generating a playlist of media content and playing media content, and, more particularly, to generating a playlist of media content and playing media content, in which the range of a playlist of media content and the order in which the media content is to be played can be easily set while media content is being played.

2. Description of the Related Art

Recently, as the storage capacity of digital storage devices such as hard disc drives and flash memories increases and media content compression technology develops, the amount of content that can be stored and processed by devices has considerably increased. Devices now have a storage capacity of tens of gigabytes, and can thus store tens of thousands of files, whereas in the past only tens or hundreds of files could be stored. For example, MPEG Layer-3 Audio (MP3) players having an 80-gigabyte storage capacity can generally store around twenty-thousand MP3 files.

This trend has been expedited since the development of various devices such as Internet Protocol Televisions (IPTVs) which can be connected to a network. For example, the iTunes Music store, which is an online music service run by Apple Computer, provides more than 3.5 million MP3 files. Devices which can be directly connected to the iTunes Music store can process millions of media files online regardless of their storage capacity.

Therefore, it is becoming more difficult for users to generate and use a playlist for indicating the order in which media content is to be played, particularly given that most portable media devices or home media devices are equipped with simple and limited input tools such as a remote control.

In order to address the above problem, various methods of generating a playlist such as a group-based music selection function, a section-repeat function, and a shuffle function or those including setting predetermined options in advance, automatically extracting contents that satisfy the options, and generating a playlist of the extracted contents have been suggested.

In the meantime, while playing media content from a playlist, a user may decide to play one selection of the media content more than once. After playing the selection more than once, the user may start to feel bored and decide to play other media content. In both cases, there is a need to edit the current playlist.

For example, user “A” who discovers while listening to a song from a top 100 music list that the Korean rock group “Jaurim” has recently released a new album. User A may decide to repeatedly listen to a song included in the new album by Jaurim. After listening to the song for three or more times, user A may decide to try other songs in the new album. For this, user A may have to change the current playlist to include all the songs in the new album.

Take as another example user “B” who is reading a book while listening to music from an album by George Winston. After listening to George Winston's music for a long time, user B may feel bored and decide to stop listening to the music and try other music by a different artist, for example, Andre Ganon's music, having a similar music style to George Winston's. User B may eventually feel bored of piano music after listening to Andre Ganon for a long time, and may look for other music such as Korean pop music or Western pop music.

Based on the above examples, users generally update a playlist to listen to music different from or similar to the music he or she is currently listening, rather than selecting specific music.

In order to meet such vague user expectations, a number of songs may be randomly selected from a predefined range of music, and the selected music may be played without the need for the users to specify a certain song or music.

However, user expectations can be classified into different levels. For example, a user may decide whether to repeatedly listen to a song currently playing. If the user decides not to repeatedly listen to the current song, he/she may decide to listen to another song or may decide to listen to a song completely different from the one currently being played or to a similar song such as a song by the same artist or a song in the same genre as the current song.

In short, while a song is being played, user expectations can be generally used for determining the range of music to be played, rather than a specific song or music.

However, related art playlist-editing tools may be insufficient to meet various user demands because they only have limited control functions and require users to specify the media content to be included in a playlist, when there is a need to edit a playlist while listening to a song.

Although, there are methods that generate a playlist that satisfies conditions set by a user, they are inconvenient in that they require the user to edit or set each condition for a playlist through a browser screen.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

Aspects of the present invention provide a method and apparatus for generating a playlist of media content and a method and apparatus for playing media content, in which the range of a playlist of media content and the order in which the media content is to be played can be easily set while media content is being played.

However, aspects of the present invention are not restricted to those set forth herein. The above and other aspects of the present invention will become apparent to one of daily skill in the art to which the present invention pertains by referencing a detailed description of the present invention given below.

According to an aspect of the present invention, there is provided a method of generating a playlist of media content, the method including providing a user interface for setting a playlist while media content is being played, and generating a playlist of media content to be played according to playlist settings set through the user interface.

According to another aspect of the present invention, there is provided an apparatus for generating a playlist of media content, the apparatus including a playlist-setting module which provides a user interface for setting a playlist while media content is being played, and a playlist-generation module which generates a playlist of media content to be played according to playlist settings set through the user interface.

According to another aspect of the present invention, there is provided a method of playing media content, the method including providing a user interface for setting a playlist while media content is being played, generating a playlist of media content to be played according to playlist settings set through the user interface, and playing the media content according to the generated playlist.

According to another aspect of the present invention, there is provided an apparatus for playing media content, the apparatus including a playlist-setting module which provides a user interface for setting a playlist while media content is being played, a playlist-generation module which generates a playlist of media content to be played according to playlist settings set through the user interface, and a content-play module which plays the media content according to the generated playlist.

### BRIEF DESCRIPTION OF THE DRAWINGS

The above and other aspects of the present invention will become apparent by describing in detail exemplary embodiments thereof with reference to the attached drawings, in which:

FIG. 1 is a block diagram of an apparatus for playing media content according to an exemplary embodiment of the present invention;

FIG. 2 illustrates the arrangement of a number of playlist filters according to an exemplary embodiment of the present invention;

FIG. 3 illustrates the change of playlist filters according to input to the input module illustrated in FIG. 1;

FIG. 4 is a flowchart illustrating a method of playing media content according to an exemplary embodiment of the present invention, which is implemented by the apparatus illustrated in FIG. 1; and

FIG. 5 is a flowchart illustrating a process of generating a selected music list as performed in the method illustrated in FIG. 4, according to an exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and repeated descriptions thereof have been omitted.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, generate means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

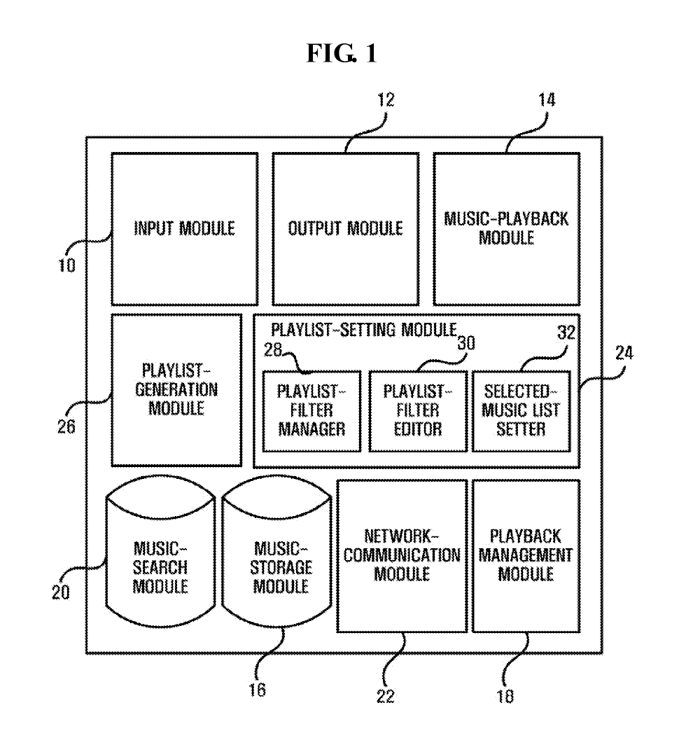

FIG. 1 is a block diagram of an apparatus for playing media content according to an exemplary embodiment of the present invention. In this exemplary embodiment, the apparatus illustrated in FIG. 1 is a music player.

Referring to FIG. 1, the apparatus includes an input module 10, an output module 12, a music-play module 14, a music-storage module 16, a play-management module 18, a music-search module 20, and a network-communication module 22. The apparatus may also include modules for providing a music-playlist-generation function such as a playlist-setting module 24 and a playlist-generation unit 26.

The playlist-setting module 24 provides, while music is being played, a user interface for setting a playlist. The user interface includes one or more playlist filters which limit the range of music that can be selected to be played, i.e., the range of a playlist, by extracting a number of songs that satisfy a predefined condition.

The playlist-setting module 24 includes a playlist filter manager 28, a playlist-filter editor 30, and a selected-music list setter 32.

The playlist filter manager 28 manages a playlist filter list including a number of playlist filters, and outputs at least one of the playlist filters to the output module 12 as graphics or text data while a song is being played. The playlist filter may be automatically output to the output module 12 while a song is being played, or alternatively, the playlist filter may be output to the output module 12 upon receiving a predefined key input.

The playlist-filter editor 30 allows a user to edit a playlist filter and thus provides a user-defined playlist filter.

The playlist-filter list managed by the playlist-filter manager 28 may include at least one of a metadata-based playlist filter which is generated based on metadata, a similarity-based playlist filter which is generated based on similarities to a song currently being played, a user feedback/user-behavior-based playlist filter which is generated based on a user's feedback and behavior, a multiple-user-based playlist filter which is generated based on data collected from a plurality of users, a recommendation-based playlist filter which is generated based on recommendations from various sources, and a user-defined playlist filter which is defined in advance by a user.

The metadata-based playlist filter may include at least one of a playlist filter which extracts the song currently being played, a playlist filter which extracts a number of songs included in the same album of the song currently being played, a playlist filter which extracts a number of songs performed by the same artist as the song currently being played, a playlist filter which extracts a number of songs belonging to a predetermined genre; a playlist filter which extracts a number of songs designated with a predetermined tag, and a playlist filter which extracts a number of songs produced within a predetermined period of time when the song currently being played was produced.

The similarity-based playlist filter may include at least one of a playlist filter which extracts a number of songs similar to the song currently being played, and a playlist filter which extracts a number of songs performed by an artist having a similarity to the artist of the song currently being played.

It may be determined whether a predetermined song has a similarity with the song currently being played by using expertise regarding the attributes of the predetermined song (e.g., the tempo of the predetermined song and the types of musical instruments used in the predetermined song) or by analyzing information regarding the sale and play of the predetermined song. However, the present invention is not restricted to this.

The user feedback/user-behavior-based playlist filter may include at least one of a playlist filter which extracts a number of songs included in a folder “my music library,” a playlist filter which extracts a number of songs that have been played more than a predefined number of times by a user, a playlist filter which extracts a number of songs having a play frequency that ranks in the predetermined top percent (e.g., the top ten percent) of all songs available, a playlist filter which extracts a number of songs that have been given a certain grade or higher by a user, a playlist filter which extracts a number of songs for which a user has shown a preference, and a playlist filter which extracts a number of songs that have been recently played.

The multiple-user-based playlist filter may include at least one of a playlist filter which extracts a number of songs that are currently popular among multiple users, and a playlist filter which extracts a number of songs that are performed by the same artist as the song currently being played and that is currently popular among multiple users.

The recommendation-based playlist filter may include a playlist filter which extracts a number of songs that are not yet included in the folder “my music library” but are deemed preferable by a user based on the songs included in the folder “my music library.”

The above-mentioned playlist filters may be defined in advance based on the results of analysis of a number of requirements of a user or may be edited and thus redefined by a user.

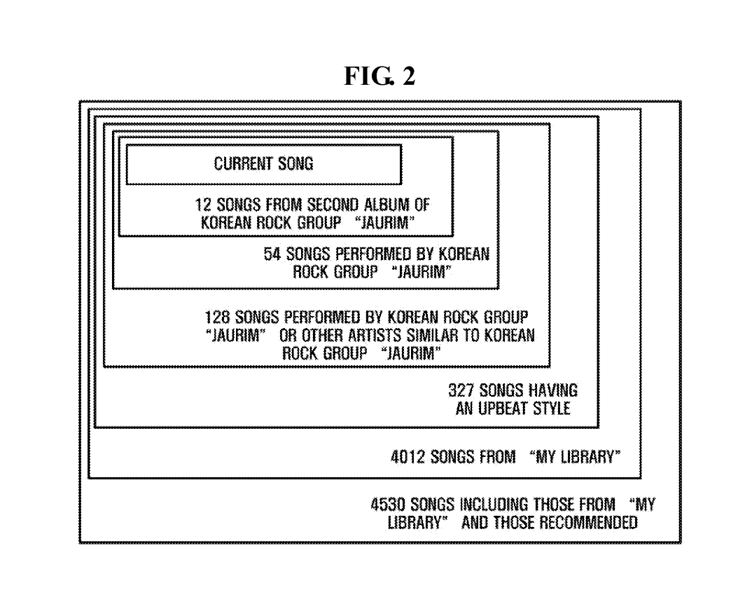

A plurality of playlist filters may be sequentially arranged by the output module 12. Specifically, a plurality of playlist filters may be arranged in ascending or descending order of the widths of respective corresponding playlist ranges to provide an easy recognition of the playlist filters by a user. For example, referring to FIG. 2, a music list including a song currently being played, a total of 12 songs from the album (e.g., the second album of Korean rock group “Jaurim”) including the song currently being played, a total of 54 songs including those performed by the same artist (i.e., Korean rock group Jaurim) of the song currently being played, a total of 75 songs including those performed by the artist of the song currently being played and those performed by artists having a similarity to the artist of the song currently being played, a total of 327 songs including those having similar styles (e.g., an upbeat style) to that of the song currently being played, a total of 4012 songs including those in the folder “my library, and a total of 4530 songs including those in the folder “my library” and those recommended by one or more users etc. may be sequentially provided. However, the present invention is not restricted to this. That is, a plurality of playlist filters may be arranged in an order set by a user or may be randomly arranged.

When a user selects a playlist filter using the input module 10, it is necessary to select a number of songs in order to generate a list of songs to be played after the play of a current song, i.e., a selected music list.

Then, the selected-music list setter 32 sets a selected music list using a plurality of songs included in a playlist range limited by the selected playlist filter. The selected music list setter 32 may randomly extract a number of songs from the playlist range limited by the selected playlist filter. The selected music list setter 32 may output a user interface for determining whether to perform a music selection operation, for example, in units of individual songs or in units of albums, to the output module 12 as graphics or text data.

If it is determined that a music selection operation is to be performed in units of albums, a number of albums may be arbitrarily selected from the playlist range limited by the selected playlist filter, and the selected albums may be played one after another. That is, a number of songs included in one album may all be played, and then a number of songs included in the next album may all be played. In this case, the play order of songs included in an album may be set to be maintained.

If it is determined that a music selection operation is to be performed in units of individual songs, a number of songs may be arbitrarily selected from the playlist range limited by the selected playlist filter regardless of their album information.

The playlist-generation module 26 generates a playlist including the songs present in the selected music list, and outputs the playlist to the output module 12.

Through the input module 10, various functions, for example, play, stop, temporary stop, and skip etc., may be selected. Also, through the input module 10, playlist filters may be changed or a playlist filter may be selected or the unit of selection of music may be changed and selected. For this, the input module 10 may include up and down keys and arrow keys. Therefore, a user can easily change playlist filters, select a playlist filter, and change (or select) the unit of selection of music using the input module 10. However, the present invention is not restricted to this. That is, the input module 10 may include various input tools, other than those set forth herein. For example, the input module 10 may include left and right keys, a dial, or a jog shuttle.

If the input module 10 includes up and down keys, the up and down keys may be volume keys for increasing or reducing the volume of music currently being played. In this case, a function shift key may be additionally provided so that the up and down keys can shift from a volume-setting function to another function such as changing playlist filters, selecting a playlist filter, or changing and selecting the unit of music selection. Alternatively, the up and down keys may change playlist filters, select a playlist filter, or change the unit of music selection when pressed for a long time. The up and down keys may increase or reduce the volume of music currently being played when pressed for only a short time.

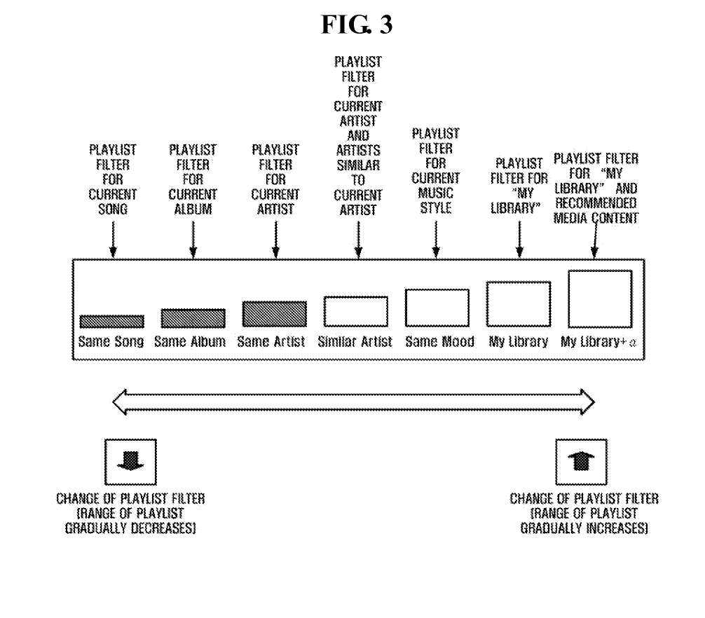

FIG. 3 illustrates the change of playlist filters according to input to the input module 10. Referring to FIG. 3, the range of a playlist becomes wider from the far left to the far right. FIG. 3 illustrates the situation when a playlist filter that extracts a number of songs performed by the same artist as a song currently being played is selected using the input module 10.

A user may combine two or more playlist filters and use the combination of the two or more playlist filters. For example, a user may apply a playlist filter which extracts a number of songs that are included in the folder “my music library” and that have a similar music style to that of a song currently being played by combining a playlist filter which extracts a number of songs included in the folder “my music library” and a playlist filter which extracts a number of songs having a similar music style to that of the song currently being played.

The output module 12 outputs a playlist. The output module 12 may serve as an interface for indicating the play state of music. The output module 12 may be a liquid crystal display (LCD) panel or a plasma display panel (PDP).

The music-playback module 14 plays music. Specifically, the music-playback module 14 may play songs that are included in the playlist. The music-storage module 16 is a physical storage space for storing music files.

The play-management module 18 manages details of the songs that have already been played. The music-index module 20 is a database for storing metadata of music. The network-communication module 22 communicates with a network and thus obtains or streams a music list or a music file through the network.

The apparatus illustrated in FIG. 1 may be applied to MP3 players, portable multimedia players (PMPs), computer equipment, or audio equipment, but the present invention is not restricted to this.

According to the exemplary embodiment of FIGS. 1 through 3, an apparatus for generating a playlist may be included in a music player, but the present invention is not restricted to this. That is, an apparatus for generating a playlist may be provided separately from a music player.

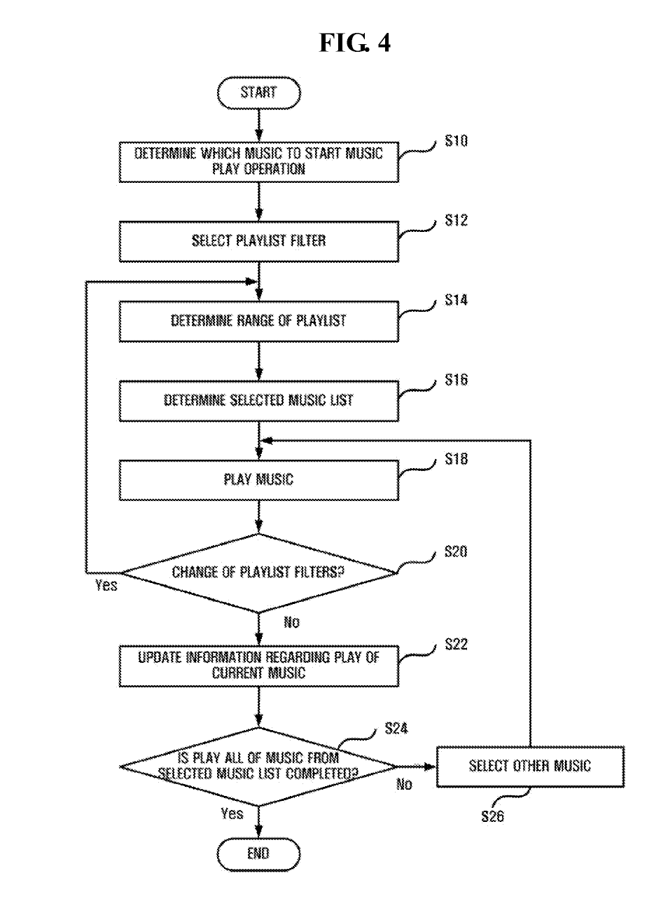

The playback of music by the apparatus illustrated in FIG. 1 will hereinafter be described in detail with reference to FIG. 4.

Referring to the method illustrated in FIG. 4, a user decides which music to start a music play operation by selecting a song or a previous playlist (S10). If the user selects at least one playlist filter output through the output module 12 while the selected song is being played (S12), the range of a playlist is determined accordingly (S14). Then, if a selected music list is determined either automatically or manually by the user (S16), a number of songs included in the selected music list are played in the order which they are selected in the selected music list (S18). In general, a playlist filter which extracts a number of songs that are included in an album currently being selected and also included in a previous playlist may be used for performing an initial music play operation, but the present invention is not restricted to this. That is, a playlist filter, other than that set forth herein, may be used, according to user settings, even for performing an initial music play operation.

If a current song in the selected music list ends without changing playlist filters (S20), existing information regarding the play of the current song in the selected music list is updated so that the current song in the selected music list can be prevented from being played again until all of the other songs in the selected music list have been played (S22).

If a change of playlist filters has occurred while the current song in the selected music list was being played, the playlist range obtained in operation S14 is changed (S14). Then, a new selected music list is generated either automatically or manually by the user using a number of songs that are within the changed playlist range (S16). Thereafter, a number of songs included in the new selected music list are played in the order which they are selected in the new selected music list.

Thereafter, it is determined whether all of the songs in the selected music list have already been played (S24). If some of the songs in the selected music list are not yet played (S26), the next song in the selected music list is selected, and the method returns to operation S18.

If all of the songs in the selected music list have been played (S24), the music play operation may be terminated, or all of the songs in the selected music list may be played again.

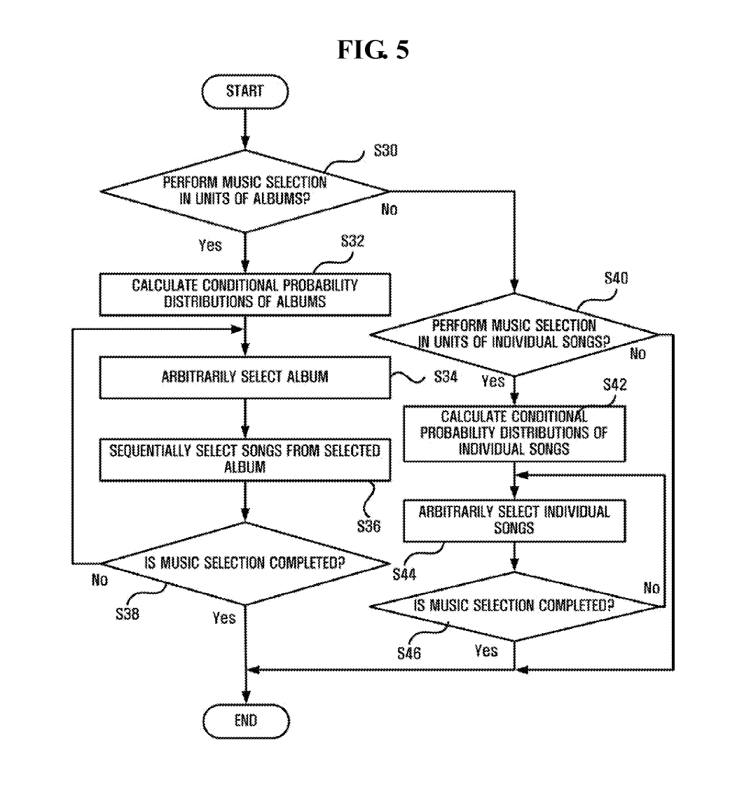

The generation of a selected music list will hereinafter be described in detail with reference to FIG. 5.

Referring to a method illustrated in FIG. 5, when a user selects a playlist filter using the input module 10, the range of a playlist is determined accordingly. The user may determine the unit of music selection. Assume that the user may decide whether to perform music selection in units of albums or in units of individual songs.

If the user decides to perform music selection in units of albums (S30), the conditional probability distribution of each of a plurality of albums is calculated (S32), and an album is selected from the plurality of albums based on the results of the calculation performed in operation S32 (S34).

According to the exemplary embodiment of FIG. 5, one of a plurality of albums is selected based on the conditional probability distribution of each of the albums, instead of randomly selecting one of the albums, in order to reflect that the user is highly likely to choose an album of his/her favorite artist over an album by other artists and to choose a recently released album over an old album. In addition, according to the exemplary embodiment of FIG. 5, the conditional probability distributions of a plurality of albums, instead of the probability distributions of the albums, are calculated because the genre of albums that can be selected in operation S34 is automatically determined by the playlist filter selected by the user. For example, if the playlist filter selected by the user is associated with rhythm & blues (R&B) albums, only R&B albums can be selected in operation S34.

Thereafter, a number of songs are sequentially selected from the selected album (S36). If an entire album-based music selection operation is completed (S38), the method ends. On the other hand, if the entire album-based music selection operation is not yet completed, the method returns to operation S24.

If the user decides to perform music selection in units of individual songs (S40), the conditional probability distributions of a plurality of songs are calculated (S42). Thereafter, a number of songs are selected from the plurality of songs based on the results of the calculation performed in operation S40 (S44).

The calculation of the conditional probability distributions of individual songs is similar to the calculation of the conditional probability distributions of albums, and thus, a detailed description thereof will be skipped.

If an entire individual music-based music-selection operation is completed (S46), the method ends. However, if the entire individual music-based music-selection operation is not yet completed, the method returns to operation S44.

In this manner, the user can easily change, while a song is being played, the range of music that can be played after the current song has been played. Therefore, the user can easily control a playlist without the need to decide which music to play whenever desired.

The present invention has been described as being applicable to a music player, but is not restricted thereto. That is, the present invention can be applied to various media such as image files, video files, user created content (UCC), and Internet Protocol Television (IPTV) commercials.

Specifically, the present invention can be applied to applications (e.g., Cyworld or Flicker) for generating a slideshow by arbitrarily browsing a number of photos as follows: a plurality of playlist filters are arranged so that a user can be sequentially provided with a single photo, a slideshow of photos included in a certain photo album, a slideshow of photos included in his/her account, a slideshow of photos included in someone else's account, a slideshow of photos having the same tag, and a slideshow of all photos available.

Also, the present invention can be applied to IPTV commercials as follows: a plurality of playlist filters are arranged so that a user can be sequentially provided with a commercial of a predetermined product, commercials of a number of products in the same series as the predetermined product, commercials of the brand of the predetermined product, commercials of the manufacturer of the predetermined product, commercials of products similar to the predetermined product, and all commercials available. In this manner, a user can easily search for a desired IPTV commercial within a short period of time and watch the identified IPTV commercial.

As described above, according to the present invention, it is possible to easily set, while media content is being played, the range of a playlist of media content to be played and the order in which the media content is to be played.

While the present invention has been particularly shown and described with reference to exemplary embodiments thereof, it will be understood by those of ordinary skill in the art that various changes may be made in the form and details without departing from the spirit and scope of the present invention as defined by the following claims.

What is claimed is:

1. A method of generating a playlist of media content to be played, the method comprising:
providing a user interface for setting at least one playlist setting while a current media content is being played; and
generating the playlist of media content to be played according to the at least one playlist setting set through the user interface.

2. The method of claim 1, wherein the providing of the user interface comprises providing at least one playlist filter which limits a playlist range.

3. The method of claim 2, wherein the generating of the playlist of media content comprises generating the playlist of media content based on the playlist range.

4. The method of claim 2, wherein the at least one playlist filter comprises at least one of a metadata-based playlist filter generated based on metadata, a similarity-based playlist filter generated based on similarities to the current media content, a user feedback/user-behavior-based playlist filter generated based on a feedback from a user and behavior, a multiple-user-based playlist filter generated based on data collected from a plurality of users, a recommendation-based playlist filter generated based on recommendations from various sources and a user-defined playlist filter defined in advance by the user.

5. The method of claim 2, wherein if the at least one playlist filter includes a plurality of playlist filters, the providing of the user interface further comprises arranging the plurality of playlist filters in ascending or descending order of widths of respective corresponding playlist ranges.

6. The method of claim 2, wherein if the at least one playlist filter includes a plurality of playlist filters, the providing of the user interface further comprises arranging the plurality of playlist filters in an order set by a user.

7. The method of claim 4, wherein the metadata-based playlist filter comprises at least one of a first metadata playlist filter which extracts the current media content, a second metadata playlist filter which extracts a number of selections of media content included in a same album of the current media content, a third metadata playlist filter which extracts a number of media content performed by a same artist as the current media content, a fourth metadata playlist filter which extracts a number of selections of media content belonging to a predetermined genre, a fifth metadata playlist filter which extracts a number of media content designated with a predetermined tag and a sixth metadata playlist filter which extracts a number of selections of media content produced within a predetermined period of time from when the current media content was produced.

8. The method of claim 4, wherein the similarity-based playlist filter comprises at least one of a first similarity playlist filter which extracts a number of media content similar to the current media content and a second similarity playlist filter which extracts a number of media content produced by an artist having a similarity to an artist of the current media content.

9. The method of claim 4, wherein the user feedback/user behavior-based playlist filter comprises at least one of a first feedback/behavior playlist filter which extracts a number of media content included in a library, a second feedback/behavior playlist filter which extracts a number of media content which have been played more than a predefined number of times by the user, a third feedback/behavior playlist filter which extracts a number of media content which have a high playback frequency, a fourth feedback/behavior playlist filter which extracts a number of selections of media content that have been given a certain grade or higher by the user, a fifth feedback/behavior playlist filter which extracts a number of selections of media content for which the user has shown a preference and a sixth feedback/behavior playlist filter which extracts a number of selections of media content that have been recently played.

10. The method of claim 4, wherein the multiple user-based playlist filter comprises at least one of a first multiple user playlist filter which extracts a number of selections of media content that have recently been popular among multiple users and a second multiple user playlist filter which extracts a number of selections of media content that were produced by a same artist as the current media content and that have recently been popular among multiple users.

11. The method of claim 4, wherein the recommendation-based playlist filter comprises a playlist filter which extracts a number of selections of media content not included in a library but are preferable by the user based on media content included in the library.

12. An apparatus for generating a playlist of media content to be played, the apparatus comprising:
a playlist-setting module which provides a user interface for setting at least one playlist setting while a current media content is being played; and
a playlist-generation module which generates the playlist of media content to be played according to the at least one playlist setting set through the user interface.

13. The apparatus of claim 12, wherein the playlist-setting module comprises a playlist filter manager which provides at least one playlist filter that limits a playlist range.

14. The apparatus of claim 13, wherein the playlist-generation module generates the playlist of media content based on the playlist range.

15. The apparatus of claim 13, wherein the at least one playlist filter comprises at least one of a metadata-based playlist filter generated based on metadata, a similarity-based playlist filter generated based on similarities to the current media content, a user feedback/user-behavior-based playlist filter generated based on a feedback from a user and behavior, a multiple-user-based playlist filter generated based on data collected from a plurality of users, a recommendation-based playlist filter generated based on recommendations from various sources and a user-defined playlist filter defined in advance by the user.

16. The apparatus of claim 13, wherein if the at least one playlist filter includes a plurality of playlist filters, the playlist filter manager arranges the plurality of playlist filters in ascending or descending order of widths of respective corresponding playlist ranges.

17. The apparatus of claim 13, wherein if the at least one playlist filter includes a plurality of playlist filters, the playlist filter manager arranges the plurality of playlist filters in an order set by a user.

18. The apparatus of claim 15, wherein the metadata-based playlist filter comprises at least one of a first metadata playlist filter which extracts the current media content, a second metadata playlist filter which extracts a number of selections of media content included in a same album of the current media content, a third metadata playlist filter which extracts a number of selections of media content performed by a same artist as the current media content, a fourth metadata playlist filter which extracts a number of selections of media content belonging to a predetermined genre, a fifth metadata playlist filter which extracts a number of selections of media content having a designated predetermined tag and a sixth metadata playlist filter which extracts a number of selections of media content produced within a predetermined period of time from when the current media content was produced.

19. The apparatus of claim 15, wherein the similarity-based playlist filter comprises at least one of a first similarity playlist filter which extracts a number of selections of media content similar to the current media content and a second similarity playlist filter which extracts a number of media content produced by an artist having a similarity to an artist of the current media content.

20. The apparatus of claim 15, wherein the user feedback/user-behavior-based playlist filter comprises at least one of a first feedback/behavior playlist filter which extracts a number of selections of media content included in a library, a second feedback/behavior playlist filter which extracts a number of selections of media content which have been played more than a predefined number of times by a user, a third feedback/behavior playlist filter which extracts a number of selections of media content which have a high playback frequency, a fourth feedback/behavior playlist filter which extracts a number of selections of media content that have been given a certain grade or higher by a user, a fifth feedback/behavior playlist filter which extracts a number of selections of media content for which a user has shown a preference and a sixth feedback/behavior playlist filter which extracts a number of selections of media content that have been recently played.

21. The apparatus of claim 15, wherein the multiple user-based playlist filter comprises at least one of a first multiple user playlist filter which extracts a number of selections of media content that have recently been popular among multiple users and a second multiple user playlist filter which extracts a number of selections of media content that were produced by a same artist as the current media content and that have recently been popular among multiple users.

22. The apparatus of claim 15, wherein the recommendation-based playlist filter comprises a playlist filter which extracts a number of selections of media content not included in a library but are preferable by the user based on media content included in the library.

23. A method of playing media content, the method comprising:
providing a user interface for setting at least one playlist setting while a current media content is being played;
generating a playlist of media content to be played according to the at least one playlist setting set through the user interface; and
playing the media content according to the generated playlist.

24. The method of claim 23, wherein the providing of the user interface comprises providing at least one playlist filter which limits a playlist range.

25. The method of claim 24, wherein the generating of the playlist comprises generating the playlist of media content based on the playlist range.
